(19) United States
(12) Patent Application Publication
(10) Pub. No.: US 2024/0393136 A1
(43) Pub. Date: Nov. 28, 2024

(54) Monitoring a Resolver

(71) Applicant: ABB Schweiz AG, Baden (CH)

(72) Inventors: Richard Roberts, Gilching (DE); Werner Hösl, Nabburg (DE)

(73) Assignee: ABB Schweiz AG, Baden (CH)

(21) Appl. No.: 18/796,910

(22) Filed: Aug. 7, 2024

Related U.S. Application Data
(63) Continuation of application No. PCT/EP2022/053087, filed on Feb. 9, 2022.

(51) Int. Cl. G01D 3/08; H02K 3/28

(52) U.S. Cl. CPC G01D 3/08; H02K 3/28

(57) ABSTRACT

A resolver comprises a pair of stator windings and a rotor winding that is rotatable with respect to the stator windings and inductively coupled to these. A method for monitoring the resolver comprises exciting the rotor winding with an alternating current having an oscillation frequency and a first phase, obtaining voltages induced in the stator windings by the alternating current flowing in the rotor winding, deciding that the resolver is defective when a shift between phases of a first one of said induced voltages and of the alternating current differs from a nominal phase shift by more than a predetermined phase threshold.

### CROSS-REFERENCE TO RELATED APPLICATIONS

The instant application claims priority to International Patent Application No. PCT/EP2022/053087, filed Feb. 9, 2022, which is incorporated herein in its entirety by reference.

### FIELD OF THE DISCLOSURE

The present disclosure generally relates to methods and apparatus for monitoring a resolver and, more particularly, to monitoring a resolver associated with a joint in an articulated robot arm.

### BACKGROUND OF THE INVENTION

An articulated robot arm comprises a plurality of links, which are coupled to each other, to a base or to an end effector by rotatable joints. A link of such a robot arm usually houses a motor and a gear for driving the rotation of a neighboring joint, and power and signal wires for the motor of this link and for motors of more distal links and, possibly, of the end effector. In operation, movement of the robot tends to wear on the isolation of the wires. In many cases, the isolation will not break down abruptly, but its resistance will decrease gradually, thereby distorting measurement signals that are fed back to a controller. Such distortion can cause the controller to derive from the measurement signals a position of the robot that differs from the real position. Such a deviation not only affects the precision with which the robot can carry out a given task but also harbingers total breakdown of the isolation which, when it occurs, can cause the robot to carry out unpredictable movements that can endanger people in its vicinity.

Conventionally, a resolver comprises so-called rotor and stator windings, which are rotatable with respect to each other and are inductively coupled so that when an alternating current is flowing in the rotor winding, an alternating voltage will be induced in the stator windings. The stator windings being arranged at right angles to each other, the induction in one of the stator windings is proportional to sin 0, 0 being an orientation angle θ of the rotor, whereas in the other it is proportional to cos 0. These windings will therefore also be referred to as sine winding and cosine winding, respectively.

When the resolver is operating normally, total coupling between the rotor and stator windings does not depend on the relative orientation of the windings, i.e. the Pythagorean \sqrt{Uₛ²+U_{c}²} of the voltage amplitudes Us, Uc induced in sine and cosine windings of the stator is independent of the orientation of the rotor. When there is a defect in the insulation of wires associated to one of the stator windings, part or all off the voltage induced in it may be short circuited, so that a defect in insulation can be detected based on a variation of said sum. However, since the signal that must be evaluated in order to detect the defect is a sum of contributions from two windings, which will in most cases not become defective at the same time, the defect becomes the hard to detect the smaller the contribution from the defective winding is.

Evidently, when the rotor winding is orthogonal to the defective winding, no voltage is induced in the latter anyway, and the defect cannot be detected. When the rotor rotates out of the orthogonal orientation, the amplitude of the alternating voltage induced in the intact stator winding will decrease in proportion to the cosine of the misalignment angle, whereas in the defective winding it fails to increase. If the threshold for detection of a failure is set at, e.g., 95% of the nominal value of the above sum, the rotor will have to rotate by θ=12.9° until the failure is detected if the voltage induced in the defective winding is shunted completely. In practice, due to manufacturing tolerances, temperature effects and the like, a more generous threshold may be necessary. If the failure threshold is set at 80%, position detection by the resolver can be wrong by up to θ=±36.9° before a malfunction of the re-solver is detected.

If the induced voltage isn't shunted completely, i.e., if the insulation has a nonzero residual resistance, the angle by which the resolver can rotate before the malfunction is detected can still be larger. Therefore, when insulation gradually wears down, the defect can at first go completely unnoticed, merely causing a loss of accuracy in the movement of the robot, and, hence, a decrease in product quality.

### BRIEF SUMMARY OF THE INVENTION

There is thus a need, in particular in collaborative robot applications, for a resolver and for a resolver monitoring method by which such a deterioration can be detected in an early stage.

This need is satisfied, according to an aspect of the present invention, by a method for monitoring a resolver, the resolver comprising a pair of stator windings and rotor winding which is rotatable with respect to said stator windings and inductively coupled to these, the method comprising the steps of (a) exciting the rotor winding with an alternating current having an oscillation frequency and a first phase, (b) obtaining voltages induced in the stator windings by the alternating a current flowing in the rotor, (c) deciding that the resolver is defective if a shift between phases of a first one of said induced voltages and of the alternating current differs from a nominal phase shift by more than a predetermined phase threshold.

Monitoring the phases of voltages induced in the stator coils has a substantial advantage over monitoring total coupling in that a signal from a potentially defective winding can be evaluated directly, instead of first combining it with a signal from the other, presumably intact winding, and then evaluating the result, so that higher sensitivity is to be expected. When the resolver is intact, and current through the stator windings is negligible, the voltages induced in both stator windings should have the same phase shift with respect to the excitation current. When a defect in insulation enables a cur-rent to flow in one of the stator windings, it can be expected to affect the phase of the voltage due to the inductivity of the winding itself.

Deciding whether said first induced voltage is critically phase-shifted can comprise the steps of (d) deriving a reference signal from the alternating current, wherein the reference signal has the oscillation frequency and is phase shifted with respect to the alternating current by said nominal phase shift, (e) detecting a phase difference between the reference signal and said first induced voltage, and (f) deciding that the resolver is defective if said phase difference exceeds the phase threshold.

The operating temperature of the resolver may have an effect on the phase shift between the exciting current and the first induced voltage in a perfectly intact resolver. Since operating temperatures of the two stator windings will not differ much, such an effect may be compensated by choosing the second one of said induced voltages or a signal derived therefrom as the reference signal.

According to an alternative, deciding whether said first induced voltage is critically phase-shifted can comprise the steps of (d) deriving a reference signal which has the oscillation frequency and is phase shifted with respect to the alternating current by said nominal phase shift plus or minus π/2, (c) detecting a phase difference between the reference signal and said first induced voltage, (f) deciding that the resolver is defective if said phase difference differs from ±π/2 by more than the phase threshold.

According to this alternative, when the phase difference between the reference signal and said first induced voltage is ±π/2, an integral over time of a product of the first induced voltage and the reference signal will be zero. Therefore, by calculating the integral, a phase shift different from ±π/2 can be detected with high sensitivity.

Since the second induced voltage will be zero while the rotor windings is orthogonal to the associated stator winding, it can be desirable to generate the reference signal independently from said induced voltages, e.g. by an oscillator which is tuned to the oscillation frequency and is phase coupled to the reference signal, or by mono-stable circuitry triggered by the reference signal.

The nominal phase shift can be made adaptable; in particular it may be contemplated to measure an existing phase shift between the exciting current and the induced voltages at a predetermined instant at which the resolver is assumed to be intact, e.g., when it is used for the first time after having been built into a device, such as an articulated robot arm, and to set the phase shift measured at that instant as the nominal phase shift.

The decision of step (c) could be based on whether a time integral of the induced voltage times an appropriately defined normal signal exceeds a predetermined threshold. When the induced voltage has the nominal phase shift, and the normal signal is phase shifted by 90° with respect to the reference signal, such an integral, taken over an integer number of periods of the exciting current, would be zero, and a significant deviation from zero might be regarded as indicative of a defect.

In practice, such an integral can be approximated, more or less precisely, by numerical means, based on samples of the first induced voltage, said samples at least comprising first samples obtained at a first predetermined sampling phase of the alternating current.

The first predetermined sampling phase should be selected so that when the phase shift between the alternating current and said first induced voltage is the nominal phase shift, sampling times of said first samples are shifted with respect to a peak of the first induced voltage, and are preferably synchronized with zero crossings of the first induced voltage. Thus the samples will be zero while the resolver is intact, and whenever the first samples differ from zero by more than an allowed voltage threshold, the resolver can be assumed to be defective.

A second sampling phase for obtaining second samples is preferably selected so that when the phase shift between the alternating current and said first induced voltage is the nominal phase shift, the first sampling phase is at a maximum of the first induced voltage. While the resolver is intact, second samples from both stator windings can be used for determining the orientation of the rotor.

A third sampling phase for obtaining third samples is preferably opposite in phase to the second sampling phase. Thus, second and third samples will usually have opposite signs but identical amounts, and will cancel out in a numerical integration. If they do not cancel out, they indicate a DC bias in the samples, which can be taken account of when evaluating the first samples.

A straightforward way of taking into account a possible DC bias is by judging the phase threshold to be exceeded if said first samples differ from the average of said third and second samples by more than an allowed voltage threshold.

According to a second aspect, the invention provides a resolver controller comprising a power supply for providing an alternating current having an oscillation frequency and a first phase to a rotor winding of a resolver, and a processor adapted to obtain voltages induced in the stator windings by the alternating current flowing in the rotor; and to decide that the resolver is defective if a shift between phases of a first one of said induced voltages and of the alternating current differs from a nominal phase shift by more than a predetermined phase threshold. The same controller may comprise calculating means for deducing an angular position of the resolver from voltages sampled from said stator windings.

According to a further aspect, the disclosure describes a resolver assembly comprising the resolver controller as defined above and an associated resolver. Such an assembly can further comprise an articulated robot arm having a joint to which the resolver is associated.

According to a still further aspect, embodiments of the disclosure include a computer-readable storage medium having stored thereon a plurality of instructions which, when executed by a processor, cause the processor obtain voltages induced in the stator windings by the alternating a current flowing in the rotor; and to decide that the resolver is defective if a shift between phases of a first one of said induced voltages and of the alternating current differs from a nominal phase shift by more than a predetermined phase threshold.

### BRIEF DESCRIPTION OF THE SEVERAL VIEWS OF THE DRAWING(S)

FIG. 1 is a schematic view of a robot and its controller in accordance with the disclosure.

FIG. 2 is a schematic diagram of a resolver in accordance with the disclosure.

FIG. 3 is a block diagram of the robot and its controller according to an embodiment of the disclosure.

FIG. 4 is a block diagram of the controller according to another embodiment of the disclosure.

### DETAILED DESCRIPTION OF THE INVENTION

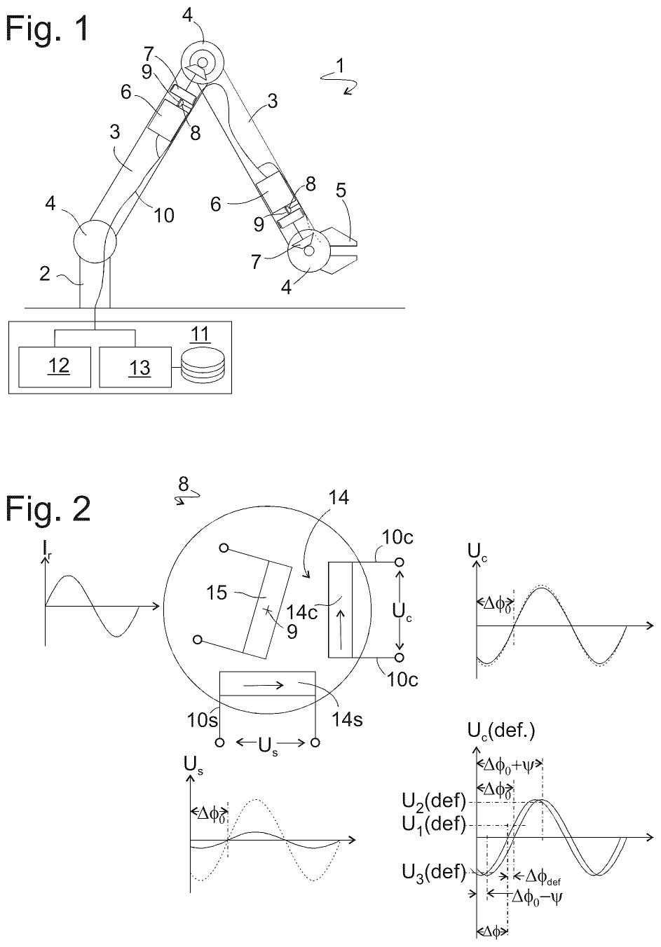

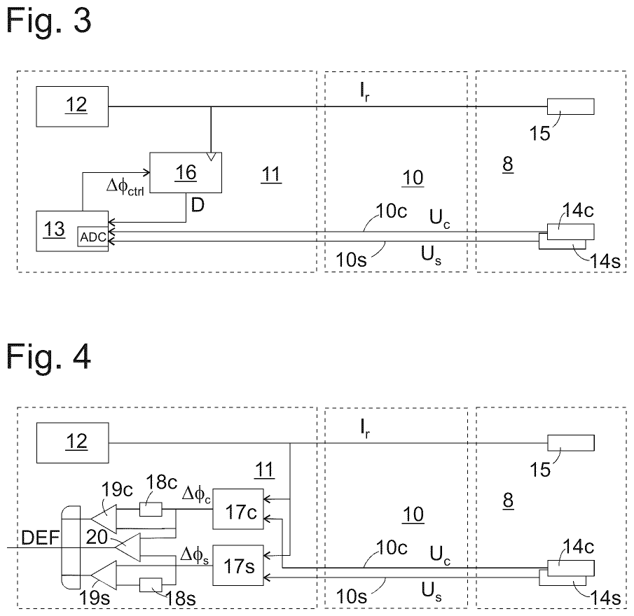

FIG. 1 is a schematic view of a robot system comprising an articulated robot arm 1. The robot arm 1 has a stationary base 2 fixed to a support, and a plurality of links 3 that are rotatably connected to each other and to the base 2 by joints 4. The most distal link carries an end effector 5. The links 3 are shown with part of their casing removed, so that motors 6 and gears 7 for driving rotation of the joints 4 can be seen inside the casing. A resolver for measuring a rotation position could be mounted at the axis of rotation of each joint 4; in the embodiment of FIG. 1 a resolver 8 is mounted at a shaft 9 extending from the motor 6 to the reducing gear 7.

A wire harness 10 extends along the articulated arm 1 between a controller 11 on one end and the motors 6 and resolvers 8 on the other, supplying the motors 6 with energy from a power supply circuit 12, and feeding back out-put from the resolvers 8 to a processor 13. The wire harness 10 must adapt to every movement of the robot arm 1, which may wear down the isolation of individual wires in it.

FIG. 2 is a schematic diagram of one of said resolvers 8. The resolver 8 has stator windings 14s, 14c, also referred to here as sine winding 14s and cosine winding 14c, whose axes extend at right angles to one another in a plane, and a rotor winding 15 which is rotatable with respect to the stator windings around an axis of rotation perpendicular to said plane.

Power supply circuit 12 feeds an exciting current Ir to rotor winding 15 by wires of harness 10. The exciting current Ir has an oscillation frequency which is much higher than a rated maximum rotating frequency of the motor 6, e.g. between 1 and 10 kHz, so that in a cycle of the exciting current, rotation of the shaft 9 is negligible. The exciting current Ir induces alternating voltages Us, Uc in sine winding 14s and cosine winding 14c, respectively. When the resolver is operating correctly, the two voltages differ in amplitude depending on the instantaneous orientation of the rotor, i.e. in the configuration shown, with the rotor winding 15 nearly parallel to cosine winding 14c and nearly orthogonal to sine winding 14s, the amplitude of Uc is near maximum, represented by a dotted curve, whereas Us is close to zero, and phases of Us, Uc are shifted with respect to Ir by substantially the same amount ΔΦo, referred to as the nominal phase shift.

While a small load on Uc due to an insulation defect in the wires 10c extending between the cosine winding 14c and the controller 11 may not have a significant influence on the amplitude of Uc, it may cause the actual phase shift Δφ to differ noticeably, by Δφ_{def}, from the nominal phase shift Apo, as shown in the diagram Uc (def.) of FIG. 2. Of course, an insulation defect in wires 10s leading to the sine winding 14s would have the same effect on Us.

According to a first embodiment of the disclosure, the processor continuously samples Us and Uc, derives a 90° phase shifted signal from one, e.g., preferably by forming its time derivative, \dot{U}ₛ, and approximates the integral

$$E = \frac{1}{\vert {\dot{U}}_{s} \vert \vert {U}_{c} \vert} {\int }_{0}^{nT} {\dot{U}}_{s} {U}_{c} dt ,$$

nT being an integer number of periods of the exciting current Ir. When the wires of both stator windings 14s, 14c are intact and have the same phase shift Δφ relative to Ir, the integral E will be zero. Any phase shift between Us and Uc will show by E becoming different from zero, so that based on an appropriately selected threshold Emax, the resolver 8 can be judged to be defective if |E|≥Eₘₐₓ.

In order to prevent a DC bias on one of Us and Uc or some other outside interference from causing the integral E to diverge, a high-pass filter can be provided. Such a filter can be located between each of the wires 10s, 10c and input ports of the processor 13, or it may be implemented by software within the processor 13, operating either on each of the input signals Us and Uc, or on a product of both, such as \dot{U}ₛU_{c}. The high-pass filter is transparent at the frequency of the exciting current Ir, but should block the rated maximum rotating frequency of the motor 6.

The above embodiment has a problem in that whenever the rotor winding 15 is perpendicular to one of the stator windings 14s, 14c, no voltage is induced in that winding, and the phase shift Δφ cannot be measured. This problem can be overcome by associating an electric oscillator to each of the stator windings 14s, 14c, which is phase coupled to the induced voltage Us, Uc of its associated stator, and from which a signal proportional to \dot{U}ₛ/|\dot{U}s| or \dot{U}_{c}/|\dot{U}_{c}| can be derived even when the rotor orientation causes Us or Uc to be zero.

When the phase shift Δφ₀ does not vary much due to temperature or other environmental conditions of the resolver, an oscillator or a delay circuit 16 may be directly connected to the wire exciting current Ir from power supply circuit 12. Processor 13 is connected to both the power supply circuit 12 and each stator winding 14s, 14c, so as to measure, in an initialization procedure, a phase shift between Ir and Us or Uc, which, when the resolver 8 is new and free from defects, will be Apo. Processor 13 programs a phase shift of the oscillator or a delay of the delay circuit 16 based on the measured phase shift Δφ₀. E.g. the delay circuit 16 may be a programmable counter designed to count between zero and an initialization value after having been triggered by e.g. a zero crossing of Ir, and to toggle an output signal D between 1 and −1 each time it finishes counting. By setting an appropriate initialization value, the processor 13 synchronizes toggling of the delay circuit output D with a maximum of induced voltages Us or Uc of intact resolver 8, or, in more general terms, sets a 90° phase shift between D and Us or Uc. By periodically sampling D, Us and Uc, processor 13 evaluates

$${E}_{c} = \frac{1}{\vert {U}_{c} \vert} {\int }_{0}^{nT} {DU}_{c} dt and {E}_{s} = \frac{1}{\vert {U}_{c} \vert} {\int }_{0}^{nT} {DU}_{s} dt$$

and detects a defect of the resolver whenever |Eₛ| or |E_{c}| equals or exceeds Emax.

According to a second, particularly simple embodiment, processor takes a first sample U1 of Us and Uc once per period of Ir, namely at the nominal phase shift Δφ₀ relative to Ir. Alternatively, similar to what has been outlined above, Uc may be sampled at a zero phase shift relative to Us based directly on Us or on an oscillator synchronized to Us, and vice versa. In either case, while the induced voltage Uc holds the nominal phase shift Δφ₀ relative to Ir, samples U1 will be zero, whereas in case of a phase shift Δφ_{def} of, for example, 10°, the sample U1 (def) (see diagram Uc (def) of FIG. 2) will amount to sin 10°=0.1736 times the peak voltage of Uc.

A DC component might be induced in Uc for other reasons than a defective insulation, for example auxiliary circuitry connected to the feed wires of winding 14s or 14c. It may therefore be necessary to distinguish between such a DC component and a deviation from the nominal phase shift. For doing this, additional samples are needed. According to a third embodiment, therefore, second and third samples U2, U3 are collected in each period of Ir, namely at phases Δφ₀−ψ and Δφ₀+ψ. When there is no DC component, these samples U2, U3 should be proportional to sin(−ψ) and sin(ψ), respectively, so that the average of both should vanish. When circuitry connected to the windings 14s, 14c is known to produce a certain DC bias, the average (U2+U3)/2 can be compared to U1, and the resolver is judged to be defective if either (U2+U3)/2 is outside an expected range or if |U1−(U2+U3)/2| exceeds a predetermined threshold.

While the resolver 8 is intact, and Us and Uc have the nominal phase shift Δφ₀ relative to Ir, the amplitudes of Us and Uc can be measured, and hence the orientation of the rotor can be determined, by sampling Us and Uc at their respective peaks or troughs, at phases Δφ₀−π and Δφ₀+π. It is convenient, therefore, to choose ψ=π, and to collect the second and third samples at phases Δφ₀−π and Δφ₀+π, respectively. Thus, the same circuitry or software for processor 13 can be used both for determining the amplitudes of Us and Uc and for detecting a possible defect.

FIG. 4 illustrates an alternative structure of controller 11. The controller has two branches for processing voltages Us and Uc induced in sine and cosine winding 14s, 14c of the resolver. Since both branches have identical structure, it is sufficient to describe structure and operation of one of them here. A phase detector 17s is connected to power supply circuit 12, on the one hand, and to winding 14s on the other, in order to detect and output a phase difference Aps between the excitation current Ir and induced voltage Us.

The phase detector 17s has its output connected to a storage cell 18s. The storage cell 18s is controlled to store a phase difference Aps output to it when the resolver is operated for the first time or when it has been reset after maintenance or repair. A comparator 19s has one input connected to storage cell 18s and another connected to phase detector 17s, so as to receive the phase shift stored in storage cell 18s as a nominal phase shift Δφ₀, and the phase shift Δφₛ from phase detector 17s as an instantaneous phase shift. Comparator 19s compares the difference |Δφ₀−Δφₛ| mod π between the two phase shifts with a predetermined threshold, and outputs a signal DEF indicative of a defect of the resolver when the difference exceeds the threshold. It should be noted that the phase difference here should be confined to a range from 0 to π by the mod π operation and not to 0 to 2π, as might be expected, since an abrupt phase change by π will be observed in a perfectly functional resolver whenever the rotation of the rotor causes one of the induced voltage Us or Uc to switch its sign.

A further comparator 20 may be connected to both phase detector 17s, 17c in order to detect a defect of the resolver if the difference |Δφ_{c}−Δφₛ| mod π exceeds a predetermined threshold.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method for monitoring a resolver, the resolver comprising a pair of stator windings and a rotor winding which is rotatable with respect to said stator windings and inductively coupled to these, the method comprising:
a) exciting the rotor winding with an alternating current having an oscillation frequency and a first phase;
b) obtaining voltages induced in the stator windings by the alternating current flowing in the rotor winding;
c) deciding that the resolver is defective when a shift between phases of a first one of said induced voltages and of the alternating current differs from a nominal phase shift by more than a predetermined phase threshold.

2. The method of claim 1, wherein step c) comprises:
d) deriving a reference signal which has the oscillation frequency and is phase shifted with respect to the alternating current by the nominal phase shift;
e) detecting a phase difference between the reference signal and the first induced voltage; and
f) deciding that the resolver is defective when the phase difference exceeds the phase threshold.

3. The method of claim 2, wherein the reference signal is the second one of the induced voltages.

4. The method of claim 1, wherein step c) comprises:
d) deriving a reference signal which has the oscillation frequency and is phase shifted with respect to the alternating current by the nominal phase shift plus or minus π/2;
e) detecting a phase difference between the reference signal and the first induced voltage;
f) deciding that the resolver is defective when said phase difference differs from ±π/2 by more than the phase threshold.

5. The method of claim 4, wherein the reference signal is formed by phase shifting said second induced voltage by ±π/2.

6. The method of claim 4, wherein in step e) a phase difference is detected by integrating a product of the first induced voltage and the reference signal.

7. The method of claim 2, wherein the reference signal is generated independently from the induced voltages.

8. The method of claim 1, wherein in step c) an excessive phase shift of the first induced voltage is determined based on samples of the first induced voltage, the samples at least comprising first samples obtained at a first predetermined sampling phase of the alternating current.

9. The method of claim 8, wherein the first predetermined sampling phase is selected so that when the phase shift between the alternating current and the first induced voltage is the nominal phase shift, sampling times of said first samples are shifted with respect to a peak of the first induced voltage.

10. The method of claim 8, wherein the first sampling phase is selected so that when the phase shift between the alternating current and the first induced voltage is the nominal phase shift, sampling times of the first samples are at a zero crossing of the first induced voltage.

11. The method of claim 10, wherein the phase threshold is judged to be exceeded when said first samples differ from zero by more than an allowed voltage threshold.

12. The method of claim 8, wherein a second sampling phase for obtaining second samples is selected so that when the phase shift between the alternating current and the first induced voltage is the nominal phase shift, the second sampling phase is at a maximum of the first induced voltage.

13. The method of claim 12, wherein a third sampling phase for obtaining third samples is opposite in phase to the second sampling phase.

14. The method of claim 13, wherein the phase threshold is judged to be exceeded when the first samples differ from the average of the third and second samples by more than an allowed voltage threshold.

15. A resolver controller comprising a power supply circuit for providing an alternating current having an oscillation frequency and a first phase to a rotor winding of a resolver, and a processor adapted to:
obtain voltages induced in the stator windings by the alternating current flowing in the rotor; and to
decide that the resolver is defective when a shift between phases of a first one of the induced voltages and of the alternating current differs from a nominal phase shift by more than a predetermined phase threshold.

16. The resolver controller of claim 15, further comprising a calculator for deducing an angular position of the resolver from voltage samples taken from the stator windings.

17. A tangible computer-readable storage medium having stored thereon a plurality of instructions which, when executed by a processor, cause the processor to:
obtain voltages induced in the stator windings by an alternating current flowing in the rotor winding; and to
decide that the resolver is defective when a shift between phases of a first one of said induced voltages and of the alternating current differs from a nominal phase shift by more than a predetermined phase threshold.
